(19) United States
(12) Patent Application Publication
(10) Pub. No.: US 2009/0106207 A1
(43) Pub. Date: Apr. 23, 2009

(54) Method for restricting access to search results and a search engine supporting the method

(75) Inventors: Helge Grenager Solheim, Oslo (NO); Anund Lie, Oslo (NO); Oystein Hallaraker, Oslo (NO)

Correspondence Address: BIRCH STEWART KOLASCH & BIRCH, PO BOX 747, FALLS CHURCH, VA, 22040-0747, US

(73) Assignee: Fast Search and Transfer ASA, Oslo (NO)

(21) Appl. No.: 12/285,699

(22) Filed: Oct. 10, 2008

(30) Foreign Application Priority Data
Oct. 18, 2007 (NO) 20075351

(51) Int. Cl. G06F 7/06; G06F 17/30

(52) U.S. Cl. 707/3; 707/E17.108

(57) ABSTRACT

In a method for information access, search, and retrieval over a data communication system generally, wherein a query is applied to a set of documents, a result set of the matching documents are identified. The method comprises amending the query according to the access entitlements of the current user to the original documents in source systems, in such a way that only documents the user is allowed to access directly from various source systems appear in the result set, even when the source documents reside in systems of different security domains that potentially are dependent on each other.

In a search engine (100) capable of supporting and implementing the above method, the search engine comprises as per se known subsystems for performing search and retrieval in the form of one or more core search engines (101), a content application programming interface (102), a content analysis stage (103) and a client application programming interface (107) connected to the core search engine (101) via query analysis and result analysis stages (105;106). In addition the search engine (100) for supporting the above method comprises a module (108) for amending the query.

The present invention concerns a method for restricting access to search results in form of documents retrieved from a document repository, wherein the method applies to an information access or search system, wherein a user of the information access or search system applies a search query to the document repository for retrieving a result set in the form of documents therefrom, wherein the access is restricted to those documents of the result set or all documents retrieved having an access control list matching a filter embodied as a search query, and wherein the information access or search system is implemented on a search engine.

The present invention also concerns a search engine for supporting and implementing the method in information access or search systems, wherein the search engine is applied to accessing, searching, retrieving and analyzing information from content or document repositories available over data communication networks, including extranets and intranets, and presenting search and analysis results for end users, wherein the search engine comprises at least a core search engine, a content application programming interface (content API) connected to the at least one core search engine via content analysis stage, and a query application programming interface (query API) connected to said at least one core search engine via respective query analysis and result analysis stages.

Information retrieval has traditionally involved indexing data from multiple sources. Access control to the documents has been solved by post-filtering the result sets using application programming interface (API) calls towards each source system. This has a severe impact on search latency, and makes efficient deep navigators impossible in practice. Alternatively, the search index has been set up to index access control entries with the documents to mimic the access control mechanisms of the source systems, and the query has been rewritten according to the user's access entitlements. For this solution, only documents from compatible security domains have been allowed in the result sets. Sometimes limited identity mapping mechanisms have been utilized to somewhat support different security domains.

In the following the term “document” is used for any searchable object, and it could hence mean for instance a textual document, a document represented in XML, HTML, SGML, or an office format, a database object such as record, table, view, or query, or a multimedia object. Hence “document” shall be regarded as synonymous with “content”.

The access entitlements of a user accessing an information system are determined by the set of groups the user is a member of. Users can be members of groups directly or indirectly, by being members of groups that are themselves members of other groups. Thus, to find the full set of groups, it is necessary to perform an exhaustive traversal of this membership graph, which will be very time-consuming when there is a large number of users and groups in the security domain. However, as access control is conventionally applied, memberships are evaluated for a single domain only. The above-mentioned post-filtering of search results is an example of that.

From prior art there are known several approaches to improve the speed of the graph traversal needed to determine the group memberships for a given user. Most apply to the single-domain case, where the objective is to determine the group memberships determining access entitlements for a single user in a single domain (or even, to a single object), and do not readily scale to the multiple-domain case which is essential for search with pre-filter generation.

For instance U.S. Pat. No. 7,103,784 discloses how groups are categorized as local, universal and global, and restrictions are imposed on how these categories of groups can be nested. The effect is that only a (presumably small) subset of the groups needs to be considered for cross-domain memberships. For groups with potential cross-domain memberships, it is still necessary to consult all domains to find additional members.

U.S. Pat. No. 7,085,834 discloses a process for determining the set of groups the user is a member of, but does not specifically target the multiple-domain case and has no provisions for optimizing the recursive graph traversal required to resolve nested groups.

Further U.S. Pat. No. 7,076,795 applies to group-based authorization, but discloses a particular way of organizing the tables mapping user IDs to groups and access rights. There is no provision for nested groups, the implicit assumption being that the closure of the membership relation is pre-computed. This does not scale well when group memberships are dynamic or maintained across several domains.

Finally, U.S. Pat. No. 7,031,954 concerns a method and a system for document retrieval in a network environment with web servers, where the documents are stored with different access levels and where queries are entered from web servers. Specifically U.S. Pat. No. 7,031,954 concerns post-filtering of search results. A person performing the search shall possess a unique identification code, which, however, does not recognize access control limitations. The URLs of the documents returned in a search is traversed after the search has been completed and an access control list attached to each document server is used for controlling whether the current URL is compatible with the access level of the identification code of the person who performs the search. Only documents or net addresses compatible with the access level of the user are returned, while URLs not compatible with the access level of the user are withheld and neither will the user obtain knowledge of which URLs are not compatible with the current access level.

In view of the shortcomings of the above-mentioned prior art it is hence a first primary object of the present invention is to protect documents from unauthorized access while still providing access to all documents that the current user has access to in the source systems.

A secondary object of the present invention is to avoid performing costly post-filtering and consulting every source system present in the result set as part of each query and response cycle.

Another object of the present invention is to solve any kind of cyclic or non-cyclic dependencies between different security domains that may impact the effective user rights to documents.

A further object of the present invention is to minimize the number of directory searches.

A yet further final object of the present invention is to provide a search engine capable of supporting and implementing the method of the present invention.

The above objects as well as further features and advantages are realized with a method according to the present invention, which is characterized by retrieving access entitlements from user directories in multiple domains, a first domain of the multiple domains being dependent on a second domain thereof if principals of the first domain formed by users, groups of users, or groups comprising one or more nested or unnested subgroups can be principals of the second domain, deriving domain dependencies, deriving an access sequence from the domain dependencies, accessing the user directories with the derived access sequence, computing the filter from access entitlements of the user applying the search query, evaluating the filter in the search engine before filtering the documents returned in the result set, and returning the documents having the access control list matching said filter.

The above objects as well as further features and advantages are also realized with a search engine according to the present invention which is characterized in comprising a module for amending the query to reflect the current user's access entitlements in source document repositories.

Additional features and advantages of the present invention will be apparent from the appended dependent claims.

The present invention will better be understood from the following discussion of its general concepts and features as well as from discussions that exemplify embodiments thereof by referring them to concrete applications and read in conjunction with the appended drawing figures, of which

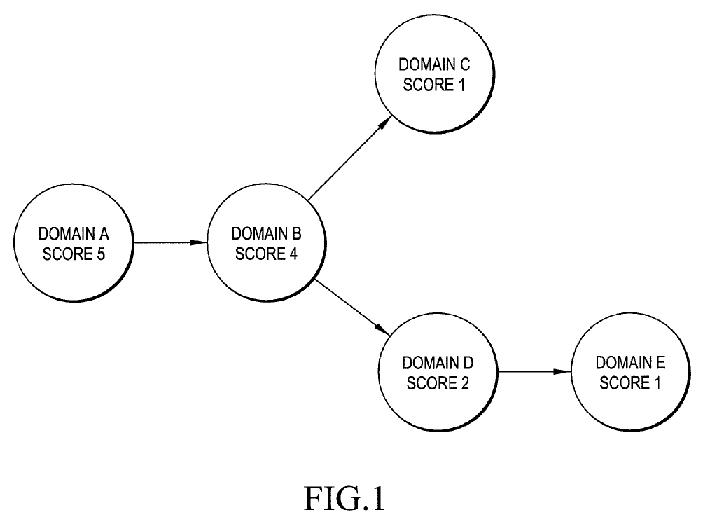

FIG. 1 shows an example of non-cyclic domain dependencies,

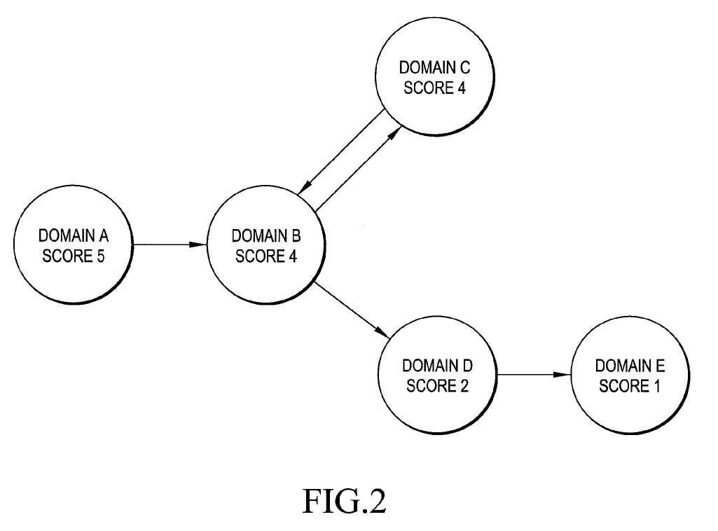

FIG. 2 an example of cyclic domain dependencies,

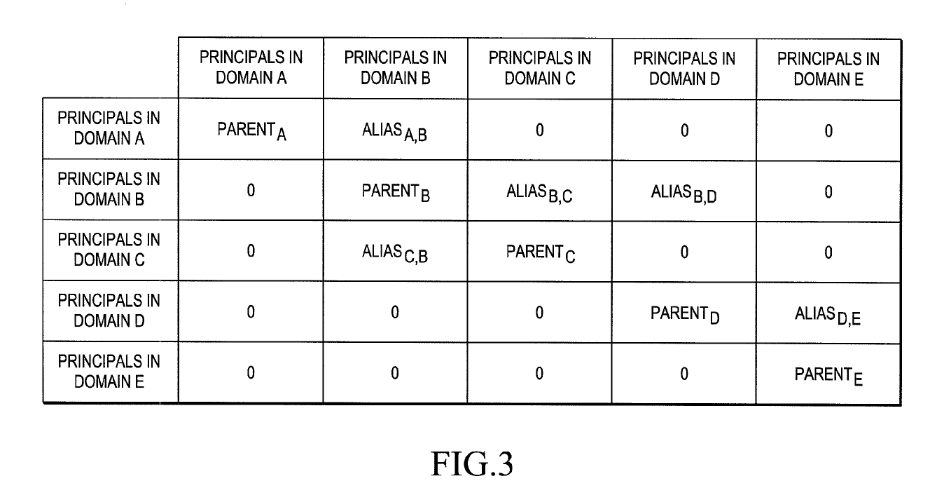

FIG. 3 an example of an adjacency matrix for cyclic domain dependencies,

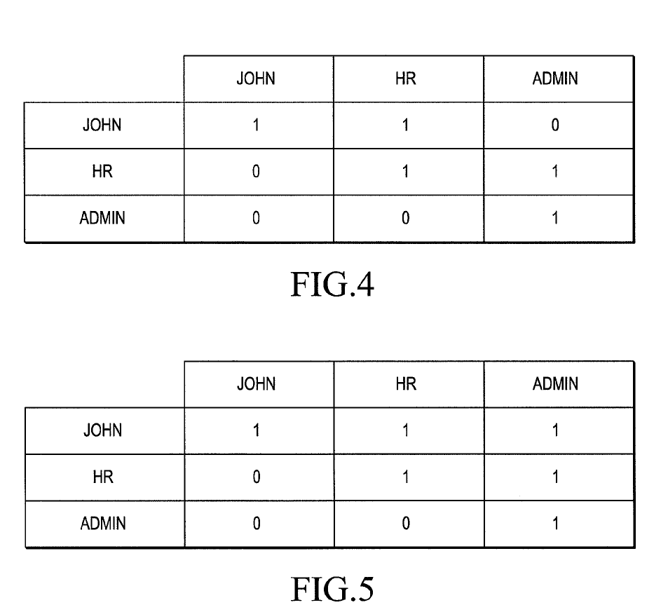

FIG. 4 an example of an adjacency matrix for a single domain,

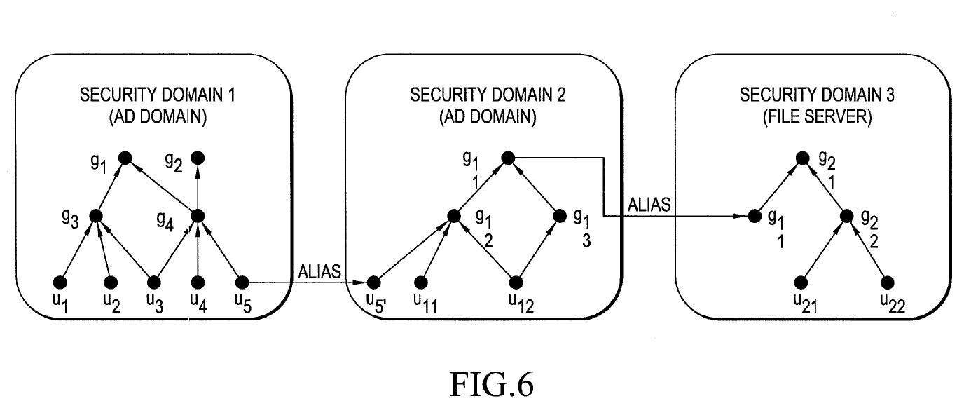

FIG. 5 an example of transitive closure of an adjacency matrix for a single domain,

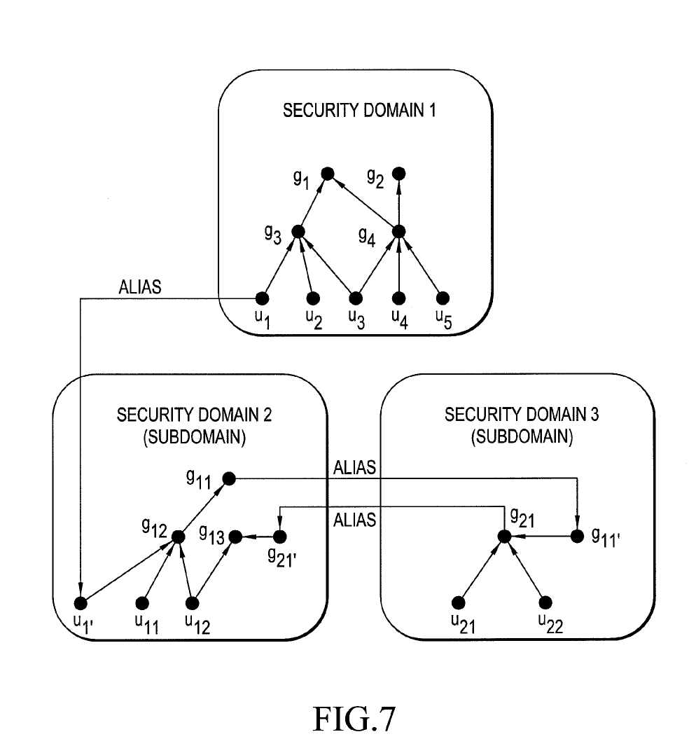

FIG. 6 two examples of Active Directory™ domains and one local file server domain with users and groups,

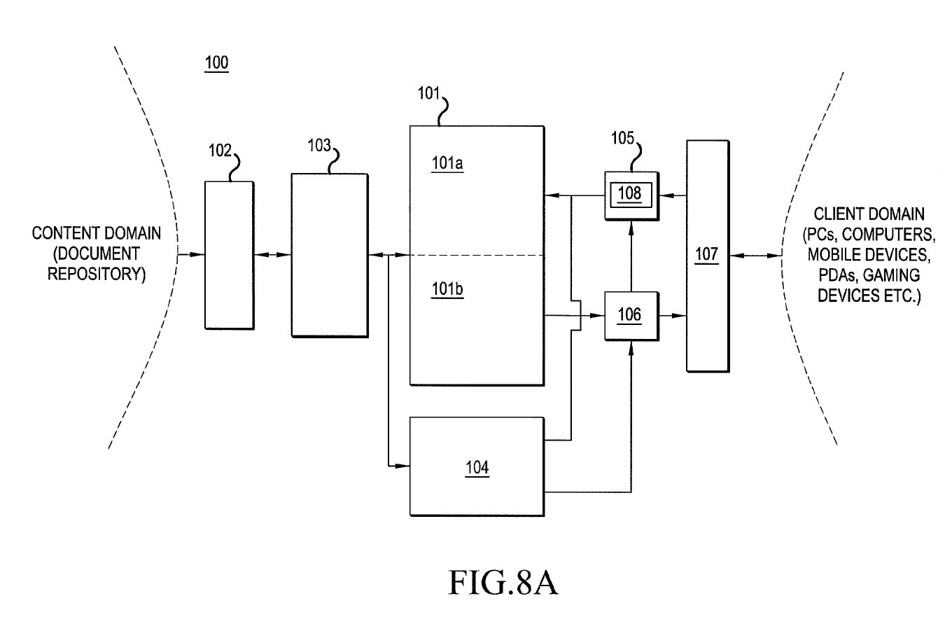

FIG. 7 three examples of Active Directory™ domains with users and groups,

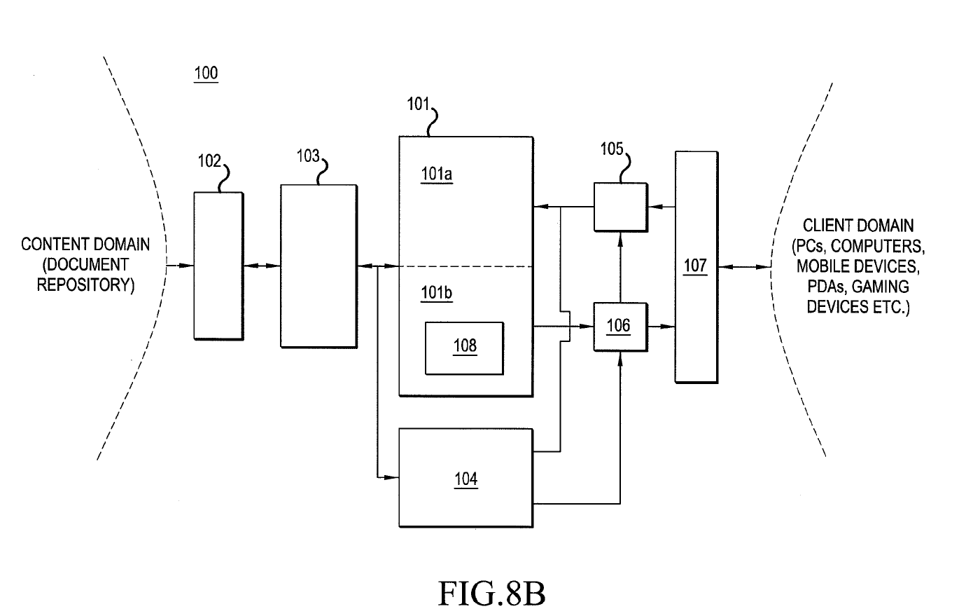

FIG. 8a schematically an embodiment of the architecture of a search engine according to the present invention, and

FIG. 8b similarly another embodiment of the same.

The general background of the present invention shall now be briefly discussed.

The method of the present invention can be regarded as an added tool or refinement applying to information access, search, and retrieval over data communication systems generally, i.e. both extranets and intranets, where there is some sort of access control enforced on the document source repositories. In that capacity it applies to search engines where the access control in multiple domains is enforced before query evaluation by generating a so-called pre-filter. This filter is evaluated as part of the query, by using access control information that has been indexed along with the document. Consequently, the user's group memberships in all domains must be determined, taking into consideration that the same user or group may occur in multiple domains, directly or through aliasing. Straightforward traversal of the membership graph will require multiple repetitive directory look-ups in multiple domains.

The present invention applies both to the protection of documents and document summaries and to the discovery of all relevant documents in all document source systems. Rather than applying post-filtering techniques or altering the permission control mechanisms of existing document source systems, this invention teaches a method that creates a search filter for the current user that matches if and only if the user has access in the source systems to the documents in question. Hence the result set from a query shall be limited to documents by enabling means and actions for rewriting the query with an additional filter.

In other words, the method according to present invention is based on calculating a security filter for each user based on the content of all security domain directories and a description of their inter-dependencies and mappings. The calculated security filter corresponds to one row in a transitively calculated adjacency matrix, preferably according to Warshall's algorithm, which to persons skilled in the art is known as one of the best methods for finding the transitive closure of a graph, starting from the adjacency matrix of the graph. The adjacency matrix of a directed graph with n vertices is the n×n matrix where each non-diagonal entry aᵢⱼ is the number of edges from vertex i to vertex j, and the diagonal entry aᵢᵢ is the number of loops at vertex i. This matrix basically defines the graph. Further it should be noted that Boolean adjacency matrix is an adjacency matrix where all numbers larger than 1 are changed to 1, and indicate not the distance but instead reachability, i.e. the notion of being able to get from one vertex to some other vertex. Since only one row in Warshall's matrix is interesting at a given time, various modifications of the algorithm can be used.—For a more comprehensive discussion of adjacency matrices and the transitive disclosure thereof by means of Warshall's algorithm, please refer to Section 7.3.2 of J. K. Truss, Discrete Mathematics for Computer Scientists, Addison Wesley, New York 1991.

The method according to the present invention uses a partial ordering of the domains and a breadth first traversal of them to guarantee completeness and minimal load on the security directories while still producing the results of Warshall's algorithm. As known to persons skilled in the art a breadth-first traversal, also called a breadth-first search, is a graph search algorithm that begins at the root node and explores all the neighboring nodes. Then for each of the nearest nodes, it explores their unexplored neighbor nodes, and so on, until it finds the goal. This is different from depth-first search which starts at the root and explores as far as possible along each branch before backtracking.

The creation of a search filter according to the present invention shall now be explained in more detail and with reference to the drawing figures. FIG. 1 shows an example of non-cyclic domain dependencies with scores for optimal ordering, and FIG. 2 an example of cyclic domain dependencies, likewise scored for optimal ordering. First a description is required of all security domains D, and their dependencies M as a list of relationships D×D.

Then, for every domain d∈D, there must be a defined user monitor UM_{d} that for every user u∈U_{d} knows the parent groups g∈G_{d} that user is a member of. The union P_{d}=U_{d}∪G_{d} is called the principals in one security domain and contains all users and groups in one security domain. Here a group can be a group of users, or a group with subgroups contained nested or unnested in the group. P is defined as the union of all P_{d} and is the set of all users and groups in all security domains.

A function parent is given as

Parent_{d}: P_{d}→P_{d} *

For every domain dependency m∈M between domains i∈D and j∈D, requiring that there is a cross-domain resolver that knows the function:

Alias_{i,j}: Pᵢ→Pⱼ*

Based on the above, an adjacency matrix A can be set up such that part of the matrix comes from the user monitors (the parent function) and the rest from the cross-domain resolvers (the alias function). As mentioned above, cyclic domain dependencies with scores for optimized ordering are shown in FIG. 2. FIG. 3 shows an example of how the dependencies for the domains in FIG. 2 map to the adjacency matrix. In FIG. 3, each row and column represents multiple rows and columns in the actual adjacency matrix, one for each principal in the domain using Warshall's algorithm.

Now the transitive closure TC of A must be determined. The transitive closure of a directed graph is the reachability region of the graph. For a directed graph with n vertices, it will be an n×n matrix and is calculated as

TC(A)=I+A+A²+A³+ . . . Aⁿ

where n may be any number up to |P|.

Whenever one user u performs a search, only one row of TC(A) is needed, namely the row that corresponds to that user. It is therefore unnecessary to calculate the entire TC(A), but only the parts that are relevant for the outcome of row u.

Before computing any row of TC(A), the order in which to visit the domains is determined by performing the following steps.

a) Calculate a score for each domain based on how many domains can be reached from it in the dependency graph. Again reference can be made to the examples of FIG. 1 and FIG. 2.

b) Sort the domains in order of decreasing score.

Then, in order to compute a single row of TC(A), corresponding to the user u the following steps shall be carried out

a) Start with an initially empty set of principals R.

b) For each domain d, create an initially empty set of principals L_{d}.

c) Add the user u to the set of principals L_{d} for the domain d where u is defined.

Now the following substeps shall be repeated until L_{d} is empty for all domains d.

a) Select the first domain d (based on the pre-computed score) with a non-empty L_{d}.

b) Add the principals in L_{d} to R.

c) Let M be the union of Parent_{d}(p) for all principals p in L_{d}.

d) Clear L_{d}.

e) Add the principals in M to R.

f) For all successors s of d in the dependency graph and all principals m in M, compute Alias_{d,s}(m) and add to Lₛ.

R now contains all groups the user u is a member of. The desired row of TC(A) contains a 1 entry for all principals in R and 0 for all others.

If there are no cycles in the dependency graph, each domain is visited only once. If there are cycles, the domains with cyclic dependencies will get the same score and may get revisited in step a) immediately above until no more parents are discovered in any of these domains.

A simple adjacency matrix A for a single domain with a user “john” is shown in FIG. 4. “john” is a member of the group “hr”, which again is a member of “admin”. The transitive closure of this will be as shown in FIG. 5. It should be noted that the row with “john” shows that he directly or indirectly is a member of both “hr” and “admin”.

Then, given this one row of TC(A) which corresponds to the current user, a search filter may be constructed by adding a disjunction of the user's group memberships like this:

SAMPLE SEARCH: test or “foo bar”

USER NAME: john

USER's PARENTS: hr, admin

RESULTING SEARCH: (test or “foo bar”) and (docacl:john or docacl:hr or docacl:admin)

If the document ACL field (called docacl) can also contain banned users where a “9” in front implies that he or she is banned, the resulting query could be something like this:

RESULTING SEARCH: (test or “foo bar”) and (docacl:john or docacl:hr or docacl:admin) andnot docacl:9john andnot docacl:9hr andnot docacl:9admin Some exemplary embodiments of the present invention shall now be given in terms of specific applications thereof.

### EXAMPLE 1

In a deployment typical for a large enterprise, there are many pitfalls with Active Directory™ and permissions. For example, it is possible to create local groups that contain universal users as members on a file server. These local groups can then be used to grant permissions on files on that file server. However, when resolving the group memberships of a user towards the global catalog or domain controller of the user, his or her group memberships on the file server will not be retrieved. So, it is necessary to also ask the file server for group memberships therein and combine these results. A similar situation arises with domain local groups.

The new approach solves this problem by simply describing all the domains (and describing a file server as a domain), their links, and which user monitor and cross-domain resolvers that know of the group memberships (parent function) and the inter-domain mappings (alias function) respectively.

FIG. 6 shows a simplified example of this scenario with three domains. Two of the domains are Active Directory™ domains (domain 1 and domain 2), while the third domain is a fileserver with local users and groups. User u₅ in domain 1 has an alias in domain 2 which is a member of two groups (g₁₁ and g₁₂) in domain 2. Group g₁₁ in domain 2 has an alias in domain 3 which is a member of a local group (g₂₁) on the fileserver. Hence, in order to resolve the user completely, all three domains must be visited.

### EXAMPLE 2

A second embodiment of the present innovation is within intranet search with mutually cyclic domains. In such a scenario, it may be necessary to visit each domain several times in order to resolve a user completely. FIG. 7 illustrates this example. In the figure there are three Active Directory™ domains, one parent domain and two sub-domains. The cyclic dependency is exemplified by the aliases between domain 2 and domain 3. In order to resolve that user u₁ is a member of g₁₃ (as well as g₁, g₃, g₁₁, g₁₂ and g₂₁), domain 2 must be visited two times since there is a cyclic dependency.

A general system for information access, search, and retrieval wherein the method according to the present invention shall be applicable, can advantageously be embodied in a search engine according to the present invention.

In the following a search engine adapted for supporting and implementing the method of the present invention shall be discussed in some detail. In order to support and implement the method of the present invention further components or modules are provided, and shall be described with reference to FIG. 8a.

The search engine 100 of the present invention shall as known in the art comprise various subsystems 101-107. The search engine can access document or content repositories located in a content domain or space wherefrom content can either actively be pushed into the search engine, or via a data connector be pulled into the search engine. Typical repositories include databases, sources made available via ETL (Extract-Transform-Load), tools such as Informatica, any XML formatted repository, files from file servers, files from web servers, document management systems, content management systems, email systems, communication systems, collaboration systems, and rich media such as audio, images and video. Repositories may belong to different security domains. Each document contains an ACL (Access Control List) which defines users and groups that have access to the document. The retrieved documents are submitted to the search engine 100 via a content API (Application Programming Interface) 102. Subsequently, documents are analyzed in a content analysis stage 103, also termed a content preprocessing subsystem, in order to prepare the content for improved search and discovery operations. The output of the content analysis is used to feed the core search engine 101.

The core search engine 101 can typically be deployed across a farm of servers in a distributed manner in order to allow for large sets of documents and high query loads to be processed. The core search engine 101 can accept user requests and produce lists of matching documents. In addition, the core search engine 103 can produce additional metadata about the result set such as summary information for document attributes.

The core search engine 101 in itself comprises further subsystems, namely an indexing subsystem 101a for crawling and indexing content documents and a search subsystem 101b for carrying out search and retrieval proper. Alternatively, the output of the content analysis stage 101 can be fed into an optional alert engine 104. The alert engine 104 will have stored a set of queries and can determine which queries that would have accepted the given document input. A search engine can be accessed from many different clients or applications which typically can be mobile and computer-based client applications. Other clients include PDAs and game devices. These clients, located in a client space or domain will submit requests to a search engine query or client API 107. The search engine 100 will typically possess a further subsystem in the form of a query analysis stage 105 to analyze and refine the query in order to construct a derived query, which is the one actually executed by the core search engine 101. The purpose of this refinement can be to extract more meaningful information, or, as in the case of this invention, to amend the query with system-defined security policies. Thus, this subsystem may include a security transformer 108 which is responsible for generating a security filter for the user issuing the query. Finally, the output from the core search engine 101 is typically further analyzed in another subsystem, namely a result analysis stage 106 in order to produce information or visualizations that are used by the clients. This subsystem may include a security post-filtering module which is responsible for verifying that the user has access to the documents in the search result by communicating with the document repositories.—Both stages 105 and 106 are connected between the core search engine 101 and the client API 107, and in case the alert engine 104 is present, it is connected in parallel to the core search engine 101 and between the content analysis stage 103 and the query and result analysis stages 105;106.

In order to support and implement the present invention the search engine 100 as known in the art must be provided with a module 108 corresponding to the security transformer. The module 108 is provided in the query analysis stage 105. Alternatively, as shown in FIG. 8b, the module 108 may be located in the core search engine 101, performing the same function.

The present invention discloses how the access permissions of the user issuing a query can be found effectively in an environment with multiple dependent security domains and provides a solution to the challenges such domains represent while using the existing security domain infrastructures without doing post-filtering. By evaluating dependencies between security domains and finding the optimal order of domains, the security filter generation delay is minimized and the perceived quality of a search engine is increased. Moreover, by processing inter-domain dependencies, the method according to the present invention avoids doing potentially expensive post-filtering of documents, thereby increasing query throughput in a distributed search engine. The dependencies between domains are used to further cut off the search and avoid look-ups in domains that cannot contribute, in particular repetitive visits to the same domain.

Thus the present invention represents a considerable improvement of the commonly applied methods for document authorization in information access, search, and retrieval, as set out and detailed hereinabove.

1. A method for restricting access to search results in form of documents retrieved from a document repository, wherein the method applies to an information access or search system, wherein a user of the information access or search system applies a search query to the document repository for retrieving a result set in the form of documents therefrom, wherein the access is restricted to those documents of the result set or all documents retrieved having an access control list matching a filter embodied as a search query, wherein the information access or search system is implemented on a search engine, and wherein the method is
characterized by
retrieving access entitlements from user directories in multiple domains, a first domain of the multiple domains being dependent on a second domain thereof if principals of the first domain formed by users, groups of users, or groups comprising one or more nested or unnested subgroups, can be principals of the second domain,
deriving domain dependencies,
deriving an access sequence from the domain dependencies,
accessing the user directories with the derived access sequence,
computing the filter from access entitlements of the user applying the search query,
evaluating the filter in the search engine,
filtering the documents returned in the result set, and
returning the documents having the access control list matching said filter.

2. A method according to claim 1,
characterized by
describing domain dependencies explicitly, and
making them available as an input for deriving the access sequence.

3. A method according to claim 2, wherein said domain dependencies form a partial order,
characterized by
visiting the domains in a topologically sorted order such that each domain is visited at most once.

4. A method according to claim 2, wherein said domain dependencies exhibit cycles,
characterized by resolving cyclic dependencies by identifying minimal cycles, and
iterating over the domains involved until no further groups are added to a set of access entitlements.

5. A search engine (100) capable of supporting and implementing the method according to any of the preceding claims in information access or search systems, wherein the search engine (100) is applied to accessing, searching, retrieving and analyzing information from document or content repositories available over data communication networks, including extranets and intranets, and presenting search and analysis results for end users, wherein the search engine comprises at least a core search engine (101), a content application programming interface (102) (content API) connected to the at least one core search engine (101) via content analysis stage (103), and a query application programming interface (107) connected to said at least one core search engine (101) via respective query analysis and result analysis stages (105;106), and wherein the search engine (100) is
characterized in comprising a module (108) for amending a search query to reflect a current user's access entitlements in source document repositories.

6. A search engine (100) according to claim 5,
characterized in that the module (108) is provided in the query analysis stage (105).

7. A search engine (100) according to claim 5,
characterized in that the module (108) is provided in the at least one core search engine (101).

8. A search engine (100) according to claim 5,
characterized in that the module (108) is adapted for amending the search query as a security filter for the current user.

9. A search engine (100) according to claim 5,
characterized in that a post-filtering module is included in the result analysis stage (106), said post-filtering module communicating with the document repository for verifying a user access to documents returned in a search result.
